(19) United States
(12) Patent Application Publication
(10) Pub. No.: US 2021/0055253 A1
(43) Pub. Date: Feb. 25, 2021

(54) METHOD OF MANUFACTURING A SENSOR ELEMENT AND ION-SELECTIVE ELECTRODE

(71) Applicant: Endress+Hauser Conducta GmbH+Co. KG, Gerlingen (DE)

(72) Inventors: Thomas Wilhelm, Chemnitz (DE); Matthäus Speck, Gopfersdorf (DE)

(21) Appl. No.: 16/996,594

(22) Filed: Aug. 18, 2020

(30) Foreign Application Priority Data
Aug. 21, 2019 (DE) 10 2019 122 519.1
Aug. 21, 2019 (DE) 10 2019 122 520.5
Dec. 6, 2019 (DE) 10 2019 133 454.3

(51) Int. Cl. G01N 27/36; G01N 27/333; G01N 27/30

(52) U.S. Cl. CPC G01N 27/36; G01N 27/302; G01N 27/333

(57) ABSTRACT

The present disclosure relates to a method of manufacturing a sensor element for measuring a measurand that is dependent on an ion activity in a measuring fluid, comprising: joining a carrier body comprising a base body made of a liquid-impermeable, electrically insulating ceramic material, wherein the base body has at least one through-opening that is introduced, especially in at least one defined location of the base body, to a sensor element body formed of an ion-selective, especially pH-selective, glass such that a surface of the carrier body contacts the sensor element body and is integrally joined to the sensor element body at least at individual fixation points, especially across the entire surface thereof.

### CROSS-REFERENCE TO RELATED APPLICATIONS

The present application is related to and claims the priority benefit of German Patent Application Nos. 10 2019 122 519.1, filed on Aug. 21, 2019, 10 2019 122 520.5, filed on Aug. 21, 2019 and 10 2019 133 454.3, filed on Dec. 6, 2019, the entire contents of which are incorporated herein by reference.

### TECHNICAL FIELD

The present disclosure relates to a method of manufacturing a sensor element for measuring a measurand that is dependent on an ion activity in a measuring fluid, and to an ion-selective electrode. The measurand can, for example, be a pH value or an ion concentration in the measuring fluid.

### BACKGROUND

Electrochemical sensors are used for the analysis of measuring media, especially measuring fluids, in laboratory and process measurement technology in many fields of chemistry, biochemistry, pharmacy, biotechnology, food technology, water management, and environmental metrology.

Using electrochemical processes, measurands representing ion concentrations, such as, for example, ion activities, ion concentrations or the pH value, can be detected in liquids. The substance, the activity or concentration of which is to be measured is also referred to as an analyte. The measuring medium can be a measuring fluid such as an aqueous solution, emulsion, or suspension.

In general, potentiometric sensors comprise a measuring electrode and a reference electrode, as well as a measuring circuit, which is used to detect and process measured values. The measuring and reference electrodes can be combined in a measuring probe which can be immersed in the measuring fluid. This measuring probe may also comprise the measuring circuit or at least part of the measuring circuit. The measuring probe can be connected for communication to a higher-level unit, for example, a measuring transducer, an electronic operating device, a computer, or a controller, via a cable or wirelessly. The higher-level unit can be used to further process the measurement signals detected by means of the probe, or measured values ascertained therefrom, and to operate the measuring probe.

In contact with the measuring medium, the measuring electrode forms an electrochemical potential that is dependent on the activity of the analyte in the measuring medium, whereas the reference electrode provides a stable electrochemical reference potential that is largely independent of the analyte concentration. The measuring circuit generates an analog or digital measurement signal, which represents the electrical potential difference between the measuring electrode and the reference electrode and, consequently, the activity of the analyte in the measuring medium. The measurement signal is output, if necessary, from the measuring circuit to the higher-level unit, which further processes the measurement signal. Partial or complete further processing of the measurement signal in the measuring circuit of the measuring probe is also possible.

The reference electrode is often designed as an electrode of the second kind, e.g., as a silver/silver chloride reference electrode, and is electrically conductively connected to the measuring circuit. It may comprise a housing and a reference element, e.g., a silver wire coated with silver chloride, which is arranged in the housing and which is in electrolytically conductive and/or ion-conducting contact with the measuring fluid in measuring operation via a reference electrolyte contained in the housing and an electrochemical bridge, e.g., a diaphragm.

The measuring electrode comprises a potential-forming sensor element, which can comprise an ion-selective membrane or layer, depending upon the type of the potentiometric probe. Examples of such measuring electrodes are ion-selective electrodes. A traditional ion-selective electrode has a housing that is closed by the ion-selective membrane and accommodates an inner electrolyte that is in contact with the membrane. The ion-selective electrode further comprises a terminal lead, also referred to as a potential terminal lead, frequently in the form of an electrode, for example a silver-chloride-coated silver wire, which is in contact with the inner electrolyte. The terminal lead is electrically conductively connected to the measurement circuit. If the ion-selective membrane, for measuring, is in contact with the measuring fluid, the membrane substantially selectively interacts with a certain ionic species present in the measuring fluid, namely with the analyte. Changing the activity or concentration of the ion in the measuring fluid causes a relative change in the equilibrium galvanic voltage between the measuring medium and the terminal lead in contact with the ion-selective membrane via the inner electrolyte. A special case of such an ion-selective electrode, namely an electrode that selectively detects the hydronium ion activity in a measuring fluid, is the known pH glass electrode, which comprises a glass membrane as the potential-forming sensor element. The terms “ion-selective layer,” “ion-selective sensor element body,” or “ion-selective electrode” used here and hereafter refer to an ion-sensitive layer, an ion-sensitive sensor element body, or an ion-sensitive electrode, the potential of which is preferably predominantly influenced by the analyte, e.g., a specific ion type or the pH value, wherein cross-sensitivities of the layer, of the sensor element body, or of the electrode for other types of ions are not excluded but are preferably low. An ion-selective glass is understood to mean a glass that is suitable for forming such an ion-selective layer, an ion-selective sensor element body or an ion-selective layer or an ion-selective sensor element body of an ion-selective electrode.

The described conventional ion-selective glass electrodes as well as potentiometric probes with corresponding glass electrodes are characterized by good measuring properties; in the case of a pH glass electrode, this relates for example to the gradient, long-term stability, selectivity and detection limit. However, the wall thickness of the high-impedance glass membranes is typically chosen to be very thin, and therefore they have only a low mechanical stability.

It is known to apply ion-selective or pH-selective glass to a porous ceramic carrier body and thereby mechanically stabilize the sensor element. For example, U.S. Pat. No. 4,133,735 describes applying an ion-selective glass to a forsterite substrate or to a substrate made of ceramic, e.g., AlSiMAG 243. A metallic intermediate layer serves here for tapping the electrode potential.

In the DD patent specification 2184, a hollow body made of a porous ceramic is described, which is coated with hydrogen ion-selective glass. An inner buffer solution is added to the hollow body and is electrically contacted with a pick-up electrode. The glass coating is produced by applying an aqueous suspension of very finely ground pH glass to a porous clay cylinder and then baking it at about 600° C. However, no details are given in the patent specification as to how a permanently stable and crack-free glass/ceramic composite can be achieved in this way.

The published patent application DE 3607522 A1 describes a mechanically stabilized glass electrode for electrochemical measurements, which comprises a porous ceramic carrier body that is open on one side and has an inner cavity which is insulated at an open end and glazed at a closed end with an ion-selective glass, filled with a buffer solution and provided with a pick-up electrode. The coefficient of thermal expansion of the ceramic carrier body is greater than or equal to that of the ion-selective glass.

DE 10 2015 121 364 A1 describes a potentiometric sensor comprising a sensor element that is designed as a composite body made of an ion-selective membrane, for example a pH glass membrane, and a porous ceramic body impregnated with a liquid or gel electrolyte. The terminal lead is designed as a liquid junction in the form of a metal electrode contacting the electrolyte. The ion-selective material can be applied by dipping the ceramic body into a melt or by melting an ion-selective glass.

U.S. Pat. No. 3,855,098 discloses an ion-selective electrode formed of a glass tube, which is closed at one end with a ceramic disk fused onto the glass tube, wherein a glass layer made of ion-selective glass is arranged on the outer side of the ceramic disk facing away from the interior of the glass tube. The ceramic disk is made of an open-pored ceramic permeable to liquid. A liquid inner electrolyte, which is in contact with the glass layer via the pores of the ceramic disk, is present in the interior of the glass tube. A pick-up electrode dips into the inner electrolyte and is used to tap the potential of the ion-selective electrode. The ion-selective glass layer can be applied to the ceramic disk by applying a paste or an emulsion made of glass powder and a binder to the ceramic disk and subsequently firing it or by fusing a glass disk or a glass wafer.

A disadvantage of the ion-selective electrodes described in U.S. Pat. No. 3,855,098 is that the ion-selective glass layer is in contact with the potential lead formed by the inner electrolyte and the pick-up electrode only via the pores of the ceramic. This limitation of the free glass surface in the contact zone may hinder the formation of the source layer in contact with the inner electrolyte. When the glass disk is fused onto an open-pored ceramic, it is also possible for impurities from preceding processing steps of the ceramic disk to remain in the pores and impair the fusion or the stability of the joint. An open-pored substrate can also promote the formation of gas bubbles on the contact surface during melting. Moreover, there is the risk of additional creepage paths forming at the edge of the glazed surface.

Furthermore, a disadvantage of conventional glazing methods using pastes that comprise glass powder and of applying molten glass to a ceramic carrier is that the glass layer thus produced typically does not have a homogeneous thickness and, under certain circumstances, also does not have a homogeneous structure. If a glass layer as thin as possible is to be produced, which is desirable due to the thickness dependence of the impedance of ion-selective glasses, there is the risk in the described methods that the glass layer produced is not completely closed. In the described methods, bubbles can also form in the ion-selective glass layer, which can lead to undesired thickness progressions or other inhomogeneities, for example pitting, within the ion-selective glass layer. Regions in the solidified glass layer containing bubbles are susceptible to pitting due to corrosion in aggressive measuring media during the measuring operation. Such corrosion processes can lead to an undesirable change in the measuring properties of the sensor element during operation.

### SUMMARY

It is therefore an object of the present disclosure to provide an improved method of manufacturing a mechanically stable sensor element for an ion-selective electrode for electrochemical measurements.

This object is achieved according to the present disclosure by a method according to claim 1 and by an ion-selective electrode according to claim 14. Advantageous embodiments are listed in the dependent claims.

The method according to the present disclosure of manufacturing a sensor element for measuring a measurand that is dependent on an ion activity in a measuring fluid comprises:

joining a carrier body comprising a base body made of a liquid-impermeable, electrically insulating ceramic material, wherein the base body has at least one through-opening that is introduced especially in at least one defined location of the base body, to a sensor element body formed of an ion-selective, especially pH-selective, glass in such a way that a surface of the carrier body contacts the sensor element body and is integrally joined to the sensor element body at least at individual fixation points, especially across the entire surface thereof Integral joining is understood to mean, for example, melting, welding, soldering or joining via the formation of intermolecular interactions or chemical bonds.

The measurand can, for example, be a pH value or an ion concentration in the measuring fluid.

As a result of the carrier body not being glazed or immersed in a glass melt, as in the methods known from the prior art, but the ion-selective glass layer being created by joining a prefabricated sensor element body, which is formed of the ion-selective glass, to the carrier body, it is possible to produce a mechanically stabilized sensor element which has a mechanical stability that is comparable to the stabilized sensor elements described in the prior art, but which additionally has a more homogeneous ion-selective glass layer formed by the prefabricated sensor element body.

The carrier body can be formed completely, or substantially completely, by the base body made of the ceramic material. In addition to the base body made of ceramic material, the carrier body can optionally comprise further components, for example one or more coatings applied to the base body, made of other materials.

The at least one through-opening can be deliberately introduced into the ceramic material in a defined location of the base body, for example in the form of a borehole.

The sensor element body can be joined to the carrier body in such a way that the at least one through-opening is covered by the sensor element body after joining. The sensor element body can be contacted from the rear side thereof via the through-opening. The contacting can be achieved by way of an electrolyte or using an electrically conductive solid terminal lead. The term “electrically conductive” as used here and hereafter refers to electronic and/or ionic conductivity. A “solid terminal lead” is understood to mean a potential lead in which the sensor element body is directly contacted by means of an electrical conductor, especially an electron-conducting and/or ion-conducting solid body. A solid terminal lead therefore does not require a liquid or thickened electrolyte contacting the sensor element body.

The use of a liquid-impermeable, electrically insulating ceramic material having at least one through-opening deliberated introduced especially in at least one defined location, for a sensor element of an ion-selective electrode with potential dissipation via an inner electrolyte, has advantages over the disk made of an open-pored ceramic material used in the ion-selective electrode known from U.S. Pat. No. 3,855,098. While the relatively small contact area between the inner electrolyte and the ion-selective glass layer via the pores of the ceramic disk can result in an impairment of the measuring properties of the ion-selective electrode described in U.S. Pat. No. 3,855,098, the at least one through-opening of the base body can be designed in the method according to the present disclosure in such a way that the sensor element provides the desired measuring properties for use in an ion-selective electrode with potential dissipation of the membrane potential via an inner electrolyte. The through-opening can be a borehole, or an opening extending through the base body produced during a ceramic sintering process, and can thus have any desired dimensions and be introduced at a predefinable position in the carrier body.

The carrier body or the base body can have precisely one through-opening. Advantageously, the base body can have multiple, for example two or more than two, through-openings, wherein the sensor element body is joined to the carrier body in such a way that several, especially all, through-openings are covered by the sensor element body after the carrier body has been joined to the sensor element body.

The at least one through-opening, or the multiple through-openings, can be arranged in at least one, or a respective defined location of the base body.

The carrier body can be configured in the form of a plate or disk, wherein the at least one through-opening, or the multiple through-openings, extends or extend through the plate or disk. In a further embodiment, the carrier body can surround a cavity. In this case, the surface of the carrier body contacting the sensor element body can be an outer surface of a wall of the base body delimiting the cavity, the at least one through-opening, or the multiple through-openings, extending through the wall and opening into the cavity.

The sensor element body can have the form of a small plate, for example a disk. In this case, it may have mutually opposing planar surfaces, the distance of which from one another may be between 1 μm and 500 μm. In an alternative embodiment, it can also have two mutually opposing curved surfaces, e.g., coaxially arranged cylindrical surfaces, or at least sectionally spherical or substantially spherical surfaces, the distance of which from one another can correspondingly be 1 to 500 μm.

The surface of the carrier body contacting the sensor element body during joining can include at least one electrically conductive partial surface, wherein the carrier body and the sensor element body are integrally joined to one another in such a way that the electrically conductive partial surface is at least partially covered by the sensor element body. An electrically conductive surface region of the carrier body not covered by the sensor element body can be covered in a further method step with an electrically insulating coating, for example an insulating enamel coating. The electrically conductive partial surface can be used to electrically contact the sensor element body by means of a potential lead in order to implement a solid terminal lead for a potential arising at the sensor element body in contact with a measuring fluid. For example, the at least one partial surface can include an electrically conductive layer, for example made of a metal or a metal alloy or an electrically conductive ceramic. The electrically conductive layer may be arranged on a surface of the base body. The electrically conductive partial surface can surround, especially closely adjoin, the at least one through-opening, so as to be electrically contactable as a potential lead via a plated through-hole extending through the through-opening or an electrical conductor guided through the through-opening.

The method can further comprise the electrical contacting of the electrically conductive partial surface and/or of the sensor element body through the at least one through-opening of the base body. This can be carried out, for example, by integrally joining the electrically conductive partial surface and/or the sensor element body to an electrical conductor, for example by melting, soldering or welding. The electrical conductor can be, for example, an electron-conducting and/or ion-conducting solid, for example a metal wire or a conductive track.

The at least one through-opening may extend along a direction that is substantially perpendicular to the surface of the carrier body contacting the sensor element body, hereafter referred to as the longitudinal direction. It can have a diameter, measurable orthogonally to the longitudinal direction, of more than 0.1 μm, preferably of more than 0.1 mm, and particularly preferably greater than 0.5 mm. It can be configured, for example, substantially cylindrically having a substantially circular cross section, for example as a borehole. In this way, a sufficient contact surface is provided via the at least one through-opening for electrically contacting the rear side of the sensor element body and/or the aforementioned, optionally present electrically conductive partial surface of the sensor element body. This contacting can be carried out, for example, by means of an inner electrolyte or by an electrical conductor, for example a metal or a metal alloy. The at least one through-opening can have a diameter, measurable orthogonally to the longitudinal direction, of less than 5 mm, preferably less than 2 mm, or even less than 1 mm.

In one possible embodiment, the carrier body can be rod-shaped or tubular. The sensor element body can be integrally joined to the carrier body at an end face of the carrier body. An end face is understood to mean a surface extending in a plane that is intersected by a tube axis of the tubular carrier body or a longitudinal axis of the rod-shaped carrier body. The longitudinal direction of the at least one through-opening can coincide with the longitudinal axis or tube axis of the carrier body. In an advantageous embodiment, the plane in which the end face extends is substantially perpendicular to the tube axis or longitudinal axis. The end face may be the outer surface of an end wall of the carrier body. The end wall can essentially be formed by a wall of the base body, which is optionally provided on the outer side with a conductive coating, and advantageously has multiple through-openings.

The carrier body and the sensor element body can surround a cavity after being joined. An electrical conductor of a solid terminal lead or a liquid junction with an electrolyte, into which a pick-up electrode is immersed, can be arranged in the cavity.

In one possible method embodiment, the integral joining can encompass the soldering with glass solder or an enamel glass preparation.

Alternatively, the integral joining may encompass an irradiating, with laser radiation, of at least one or more fixation points located in an interface arranged between the sensor element body and the carrier body. In this way, the sensor element body can be fused, welded or soldered, for example, to the carrier body.

Alternatively, the integral joining may encompass the joining of a surface region of the sensor element body to the surface of the carrier body, using molecular adhesion forces. The molecular adhesion forces that play a role here can be van der Waals forces, hydrogen bridges or chemical bonds, depending on the material of the sensor element body and the carrier body. Such joining methods are also referred to as bonding, wringing or flashing.

In one possible embodiment, the carrier body and/or the base body can be tubular and include an end face in which the at least one through-opening is arranged. In this embodiment, the sensor element body can have a circular disk shape. For example, the diameter of the sensor element body may be substantially equal to an outer diameter of the tubular carrier body or base body. In one method embodiment, the sensor element body can be joined to the end face of the tubular carrier body or base body so as to cover the at least one through-opening and close a cavity enclosed by the carrier body or base body. A sensor element body of a sensor element manufactured according to this method can be contacted by means of a lead system arranged in the cavity made of an inner electrolyte and a pick-up electrode contacting the inner electrolyte.

A method of manufacturing an ion-selective electrode for electrochemical measurements comprises: manufacturing a sensor element according to the method according to one of the above-described embodiments; and electrically contacting at least one region of the sensor element body comprising the ion-selective glass by means of an electrically conductive potential lead.

The ion-selective electrode can be used, for example, for the pH measurement in a measuring fluid or for measuring an ion concentration in a measuring fluid.

As was already mentioned above, this contacting can be carried out by an electrolyte and a pick-up electrode contacting the electrolyte, or by an electrically conductive solid terminal lead.

In one possible embodiment, the electrical contacting can comprise the following steps: introducing an inner electrolyte into a cavity of the ion-selective electrode, which is at least partially delimited by the carrier body, in such a way that the inner electrolyte is in contact with a rear side of the sensor element body facing the carrier body via the through-opening, and contacting the inner electrolyte by means of a pick-up electrode.

In another possible embodiment, the surface of the carrier body of the sensor element can include at least one electrically conductive partial surface, the manufacturing of the sensor element comprising: integrally joining the carrier body and the sensor element body to one another in such a way that the electrically conductive partial surface is at least partially covered by the sensor element body, and wherein the electrical contacting of the sensor element body comprises a step of electrically contacting the electrically conductive partial surface and/or the sensor element body through the at least one through-opening of the base body. This can be carried out, for example, by means of integral joining to an electrical conductor, for example by soldering or welding or fusing. The electrical conductor can be, for example, an electron-conducting and/or ion-conducting solid, for example a metal wire or a conductive track.

In embodiments in which the carrier body and the sensor element body are joined so as to surround a cavity after being joined, the cavity can be used for the rear contacting of the sensor element body by a solid terminal lead arranged at least partially in the cavity. Alternatively, an electrolyte and a pick-up electrode contacting the electrolyte can be introduced into the cavity.

As was already mentioned, the carrier body or base body can have multiple through-openings, wherein the sensor element body is joined to the carrier body in such a way that several, especially all, through-openings are covered by the sensor element body after the carrier body has been joined to the sensor element body.

The present disclosure also relates to an ion-selective electrode for electrochemical measurements, comprising: a carrier body comprising a base body made of a liquid-impermeable, electrically insulating ceramic material, the base body including at least one through-opening; a sensor element body formed of an ion-selective, especially pH-selective, glass, which is integrally joined to a surface of the carrier body at least in individual fixation points; and a potential lead contacting the sensor element body in an electrically conducting manner through the at least one through-opening.

The carrier body can be formed completely, or substantially completely, by the base body made of the ceramic material. In addition to the base body made of ceramic material, the carrier body can optionally comprise further components, for example one or more coatings applied to the base body, made of other materials.

The carrier body and/or the base body can be rod-shaped or tubular or planar. It can surround a cavity, wherein the at least one through-opening leads into the cavity.

The potential lead can be designed as an electrically conductive, especially electron-conducting and/or ion-conducting, solid terminal lead or part of a solid terminal lead, for example in the form of a wire, a layer and/or a conductive track, which directly contacts the sensor element body. In an alternative embodiment, the potential lead can be formed by an electrolyte contacting the sensor element body through the through-opening and an electrically conductive electrode contacting the electrolyte.

In one embodiment, the surface of the carrier body includes at least one electrically conductive partial surface, wherein the carrier body and the sensor element body are integrally joined to one another in such a way that the electrically conductive partial surface is at least partially covered by the sensor element body and contacts the sensor element body in an electrically conducting manner, and wherein the potential lead comprises an electrical conductor, e.g., a wire or a conductive track, which contacts the electrically conductive partial surface and/or the sensor element body in an electrically conducting manner through the through-opening of the base body. As described above, the electrically conductive partial surface can surround the through-opening, so that the partial surface can be electrically contacted via a plated through-hole extending through the at least one through-opening.

If the carrier body in this embodiment is configured as a plate or disk, the unit formed of the carrier body, the sensor element body and the potential lead in the form of a solid terminal lead can be surrounded by an electrically insulating sheathing, for example made of glass or an electrically insulating polymer, which leaves at least a portion of the surface of the sensor element body exposed, but seals the location of the joint between the carrier body and the sensor element body in a liquid-tight manner. The potential lead can be guided out of the sheathing in order to form a contact point that allows the ion-selective electrode to be connected to a measuring circuit. The sheathing can be applied during the manufacture of the ion-selective electrode, for example by glazing or other customary methods. This embodiment permits a very compact design of the ion-selective electrode.

In a further embodiment, the ion-selective electrode can comprise an electrolyte, which contacts the sensor element body on the rear through the through-opening and which is in contact with a pick-up electrode. If the carrier body is tubular as described above, the carrier body and the sensor element body covering the opening surround a cavity in which the electrolyte can be present.

The ion-selective electrode may be used as an integral part of a potentiometric sensor. Such a potentiometric sensor comprises, in addition to the ion-selective electrode, a reference electrode, for example a potential-stable reference electrode of the second kind, such as a silver/silver chloride electrode, and a measuring circuit, which is configured to detect a voltage between the ion-selective electrode and the reference electrode. As explained at the outset, this voltage is a measure of the concentration of a target ion or of the pH in a measuring medium into which the ion-selective electrode and the reference electrode dip.

In a further embodiment, the ion-selective electrode can comprise a preamplifier and/or an impedance converter which is arranged in the vicinity of the sensor element formed of the carrier body and the sensor element body, and which can be connected to a potentiometric measuring circuit. One input of the preamplifier can be connected to the electrically conductive potential terminal lead of the sensor element; a second input can be at a housing potential or at a virtual ground of the measuring circuit as a reference potential. For example, if the sensor element or the ion-selective electrode is an integral part of a potentiometric sensor, in which it serves as a measuring electrode and which further comprises a reference electrode and a measuring circuit, which is configured to detect a voltage between the measuring electrode and the reference electrode and to generate a measurement signal as a function of this voltage, the preamplifier or impedance converter can be used to increase the signal-to-noise ratio of the measurement signals.

The preamplifier can be integrated into the sensor element, for example it can be arranged in a cavity within the carrier body, at the carrier body or in a housing at least partially surrounding the sensor element. The integration of a preamplifier in the signal path close to the sensor element body made of ion-selective glass is especially advantageous if the sensor element body has a high impedance.

### BRIEF DESCRIPTION OF THE DRAWINGS

In the following, the present disclosure is explained in further detail on the basis of the exemplary embodiments shown in the figures. The following are shown:

FIG. 1 shows a schematic longitudinal sectional view of an ion-selective electrode according to a first exemplary embodiment;

FIG. 2 shows a schematic longitudinal sectional view of an ion-selective electrode according to a second exemplary embodiment;

FIG. 3 shows a schematic longitudinal sectional view of an ion-selective electrode according to a third exemplary embodiment;

FIG. 4 shows a schematic longitudinal sectional view of the joint of a carrier body to a sensor element body in a first method variant;

FIG. 5 shows a schematic longitudinal sectional view of the joint of a carrier body to a sensor element body in a second method variant; and

FIG. 6 shows a schematic longitudinal sectional view of a potentiometric single-rod measuring chain for measuring an ion concentration or pH value.

### DETAILED DESCRIPTION

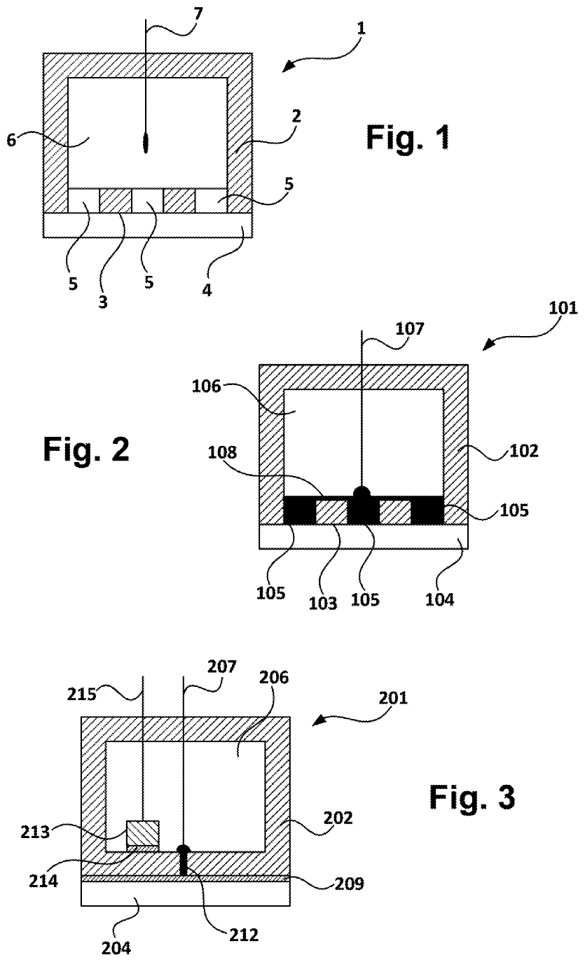

FIG. 1 schematically shows an ion-selective electrode 1 for the pH measurement according to a first exemplary embodiment. It comprises a cylindrical housing formed of a carrier body 2. In the present exemplary embodiment, the carrier body 2 is formed completely by a base body made of a ceramic material and, aside from the base body, does not comprise any further components. An outer surface of an end wall of the carrier body 2 forms an end face 3 of the carrier body 2. The end face 3 is covered by a sensor element body 4 integrally joined to the carrier body 2. The end wall has a plurality of through-openings 5, for example, in the form of boreholes, which are covered by the sensor element body 4. The sensor element body 4 is formed as a disk or plate made of an ion-selective glass, in the present example a pH glass. The thickness of the sensor element body 4 can be 1000 nm to 500 μm.

In the present exemplary embodiment, the carrier body 2 is made of a glass ceramic (for example, Vitronit® (company: Vitron), Macor® (Corning)), which has a coefficient of thermal expansion that differs by no more than 15% from that of the glass used. The glass ceramic of the carrier body 2 is liquid-tight, i.e., it either has closed pores or is pore-free. In regions in which the carrier body 2 does not have any boreholes or has other intentionally produced through-openings, the wall thereof is impermeable to liquids. The carrier body materials mentioned here can also be used for the carrier bodies or base bodies of the further exemplary embodiments described here for ion-selective electrodes or sensor elements.

The carrier body 2 and the sensor element body 4 covering the openings 5 surround a cavity 6 in which an electrolyte, for example, an aqueous buffer solution, is present. The electrolyte is contacted via a pick-up electrode that is arranged in the cavity 6 and led out of the cavity 6 via a feed-through and that serves as a potential lead 7 of the ion-selective electrode 1. The pick-up electrode may be, for example, a silver wire coated with silver chloride or another electrical conductor. The potential lead 7 can be connected to the input of a measuring circuit, which is configured to carry out electrochemical measurements by means of the ion-selective electrode 1. For example, the measuring circuit may be configured to detect a voltage between the ion-selective electrode 1 and a potential-stable reference electrode. When the end region of the ion-selective electrode 1 comprising the sensor element body 4 and the reference electrode contact a measuring fluid, for example an aqueous solution, the detected voltage is a measure of the pH value of the measuring fluid.

FIG. 2 schematically shows an ion-selective electrode 101 according to a second exemplary embodiment. It also comprises a base body made of a ceramic material, which forms a carrier body 102 of the ion-selective electrode. The carrier body 102 is designed identically to the carrier body 2 of the ion-selective electrode 1 shown in FIG. 1. On its end face 103, the carrier body 102 is integrally joined to a sensor element body 104 made of an ion-selective glass, e.g., pH glass or a sodium-selective glass. In contrast to the exemplary embodiment shown based on FIG. 1, the ion-selective electrode 101 shown in FIG. 2 comprises a solid terminal lead. For this purpose, the through-openings 105 of the carrier body 102 are filled with an electrically conductive material, for example, a metal or a metal alloy, which forms an electrically conductive layer 108 that electrically contacts the sensor element body 104. The layer 108 is electrically contacted on the rear, i.e., on the side thereof facing away from the sensor element body 104 and facing the cavity 106, by an electrical conductor serving as the potential lead 107.

FIG. 3 schematically shows an ion-selective electrode 201 according to a third exemplary embodiment in a longitudinal sectional view. It comprises a cylindrical or tubular carrier body 202, which is formed of a hollow-cylindrical base body made of a liquid-impermeable, electrically insulating ceramic and an electrically conductive coating 209 arranged on a partial surface of the base body. The base body surrounds a cavity 206. A plated through-hole 212 extending through a through-opening in the base body, via which an electrical conductor serving as the potential lead 207 contacts the electrically conductive coating 209, is guided through an end wall of the carrier body 202 covered by the conductive coating 209. A sensor element body 204 is integrally joined to the end face 203 of the carrier body 202 formed by the surface of the electrically conductive coating 209. The sensor element body 204 can be formed of a small plate or a disk made of ion-selective glass, such as a pH glass, as in the previously described exemplary embodiments.

In the exemplary embodiment shown here, a temperature sensor 213 is arranged in the cavity 206. Advantageously, it is in easily thermally conductive contact with the end wall of the carrier body 202 joined to the sensor element body 204, for example as in the example shown here, via a heat-conducting layer 214. The potential lead 207 and a signal line 215 of the temperature sensor 213 are led out of the cavity 206 and can be connected to a measuring circuit.

Various method variants of manufacturing a sensor element from a carrier body and a sensor element body are described below. Sensor elements produced in this way can be used as integral parts of ion-selective electrodes such as those described based on FIGS. 1 to 3.

In order to manufacture a sensor element for an ion-selective electrode, a sensor element body made of an ion-selective glass is integrally joined to a carrier body comprising an electrically insulating ceramic, namely such that a surface of the carrier body contacts the sensor element body and is integrally joined to the sensor body at least at individual fixation points or also across the entire surface thereof.

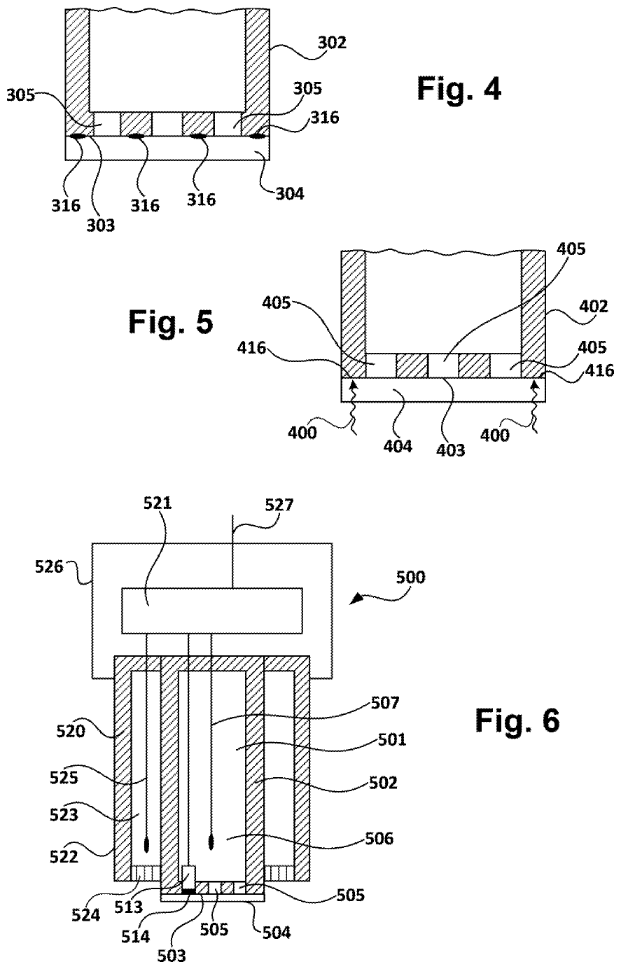

FIG. 4 schematically shows in a longitudinal section the integral joint between an end-face end region of a tubular carrier body 302 made of a ceramic base body and a small plate-shaped or disk-shaped sensor element body 304 made of an ion-selective glass. The carrier body 302 is closed at one end by an end wall having a plurality of through-openings 305. The outer surface of the end wall forms an end face 303 of the carrier body 302.

The base body forming the carrier body 302 can be creating by molding a ceramic slurry so as to form the shape shown in FIG. 4 and subsequent firing. The openings 305 can be introduced into the carrier body 302 during molding. Alternatively, after firing, they may be produced by machining the carrier body 302.

The sensor element body 304 can be produced by first creating a shaped body, for example a cylindrical rod, from a melt of the ion-selective glass, for example by drawing or by other methods known to the person skilled in the art. In a further step, a slice of the cylindrical rod is severed perpendicularly to the longitudinal axis or cylinder axis thereof by sawing or cutting. The slice thus severed can be further processed by mechanical, chemical, chemical-mechanical (CMP) or electrochemical polishing and/or thermal treatment to smooth the surfaces of the slice. Slices produced in this way or also small plates made of ion-selective glass produced in an analogous manner have very homogeneous properties; they are free, especially, of defects, such as holes or bubbles, and have a uniform thickness.

In the example of FIG. 4, a surface of the sensor element body 304 is integrally joined to the end face 303 of the carrier body 302 in multiple fixation points 316 by means of soldering. A glass solder or an enamel glass preparation can serve as the solder. Soldering encompasses, especially, applying the solder at the fixation points 316, applying a surface of the sensor element body 304 to the end face 303 of the carrier body 302, and subsequently thermally treating at least the fixation points. Alternatively, the solder can also be applied across the entire surface instead of only at individual fixation points. The thermal treatment can be carried out in the furnace, in the flame, using laser radiation or by means of microwaves.

Prior to soldering, the end face 303 of the carrier body 302 and/or the surface of the sensor element body 304 to be applied to the end face 303 during joining can be cleaned, for example by rinsing with a cleaning liquid or a cleaning gas.

Since the sensor element body 304 is defect-free and has a homogeneous thickness, the sensor element body 304 integrally joined to the carrier body 302 forms a homogeneous, defect-free and uniformly thick glass layer or glass membrane of the sensor element.

In one method variant, the integral joining of the carrier body to the sensor element body can be carried out by, especially, spot, welding, or substantially full-surface fusion. The process of welding is schematically illustrated in FIG. 5. FIG. 5 shows in a schematic longitudinal sectional view an end of a tubular carrier body 402 made of a ceramic, on the end face 403 thereof, which surrounds a plurality of through-openings 405 configured as boreholes in the end wall of the carrier body 402. A disk-shaped sensor element body 404 made of an ion-selective glass is welded to the end face 403. The carrier body 402 and the sensor element body 404 may have been produced as previously described.

So as to join the carrier body 402 to the sensor element body 404, the end face 403 of the carrier body 402 and the surface 403 of the sensor element body 404 to be joined thereto are optionally cleaned. The surfaces are then placed against one another and irradiated at fixation points 416 with laser radiation 400 focused at the fixation points 416. The surfaces of the carrier body 402 and of the sensor element body 404 resting against one another are fused at the fixation points and welded to one another.

For fusing the sensor element body 404 to the carrier body 402 across the entire surface, the surfaces, which were optionally previously cleaned, can be placed against one another and heated across the entire surface. This can be carried out, for example, by means of a laser scanning process or also with the aid of microwaves.

In a further method variant, the carrier body and the sensor element body can be integrally joined to one another by utilizing intermolecular adhesion forces, for example, van der Waals forces, hydrogen bridges or chemical bonds. This technique is also referred to as bonding or flashing. The polished surfaces of the carrier body and of the sensor element body to be joined are cleaned thoroughly and, if necessary, etched using an etchant, for example hydrofluoric acid, in order to create free bonds on the surfaces. By bringing the surfaces into contact, a durable, integral joint is formed by the action of the intermolecular adhesion forces. If necessary, the joint thus formed can be heated to promote the formation of covalent bonds.

In order to produce a sensor element for an ion-selective electrode in which a solid terminal lead by means of a conductive layer is provided, for example as is the case with the ion-selective electrode 201 shown in FIG. 3, the sensor element body 204 can initially be integrally joined to the carrier body 202 at the end face 203 thereof comprising the electrically conductive coating 209 in a manner analogous to that described above based on FIGS. 4 and 5, for example by fusing, welding or soldering.

The ceramic base body of the carrier body 202 can first be formed as previously described by molding and subsequently firing a ceramic slurry. Depending on the material of which it is made, the conductive coating 209 of the carrier body 202 can be produced on the base body by means of various coating methods, which are essentially known to the person skilled in the art. For example, it can be produced by applying and curing a polymer preparation, by applying a suspension comprising ceramic particles and a subsequent thermal treatment, or by applying and curing a suspension comprising metallic particles, for example a conductive paint. If the coating is a metallic coating, it can also be produced by sputtering, vapor deposition (PVD or CVD) or by metal deposition from a solution. A metallic coating can also be produced by placing a metal foil on the carrier body and, if necessary, subsequently joining, for example integrally, the metal foil to the carrier body.

In a further step, after the sensor element body 204 has been integrally joined to the carrier body 202, the circumferential surface of the sensor element thus formed, composed of the carrier body 202 and sensor element body 204, can be covered with an insulating coating. The insulating coating can be produced, for example, by applying and curing a polymer preparation, or by applying and a subsequent thermal treatment of a suspension containing glass or ceramic particles. Advantageously, the coating is applied so as to cover an interface between the surface of the carrier body 202 comprising the electrically conductive coating 209 and the surface of the sensor element body 204 resting thereagainst in an end region of the carrier body 202 intended for immersion in a measuring fluid.

FIG. 6 shows a potentiometric sensor 500 comprising an ion-selective electrode 501 and a reference electrode 520 in a longitudinal sectional view. The ion-selective electrode 501 is designed analogously to the ion-selective electrode 1 shown in FIG. 1. In alternative embodiments, it can be designed analogously to the ion-selective electrodes 101 or 201 shown in FIGS. 2 and 3.

In the present exemplary embodiment, the ion-selective electrode 501 comprises a housing formed by a tubular carrier body 502. The tubular carrier body 502 is formed of a liquid-impermeable, electrically insulating ceramic and has a wall including a plurality of through-openings 505 configured as boreholes at an end-face end. At the end-face outer surface 503 of the wall, the carrier body 502 is integrally joined to a sensor element body 504 made of an ion-selective glass. In the present example, the ion-selective glass is a pH-selective glass, for example MacInnes glass or another known glass that can be used in glass electrodes for potentiometric pH measurement. The integral joint can have been created according to one of the methods described above. At its opposite end, the carrier body 502 is sealed in a liquid-tight manner by a further end wall or by a plug or a polymer closure. An inner electrolyte, which can comprise an aqueous buffer solution, for example, is accommodated in the cavity 506 surrounded by the sensor element body 504 and the carrier body. The inner electrolyte is contacted in an electrically conducting manner by a pick-up electrode that is arranged in the cavity 506 and serves as a potential lead 507 of the ion-selective electrode 501. The potential lead 507 is led out of the cavity 506 through a feed-through and connected to the input of a measuring circuit 521.

In addition, a temperature sensor 513 is arranged in the cavity 506 and is in heat-conducting contact with the sensor element body 504 via one of the openings 505 in the end wall of the carrier body 502. In the present example, the temperature sensor 513 is in contact with the sensor element body 504 via a heat-conducting layer 514.

The reference electrode 520 comprises a housing 522 that surrounds the ion-selective electrode 501 and encloses a second, substantially annular cavity 523. The housing 522 of the reference electrode is closed at an end-face end by an annular porous diaphragm 524, which is clamped, glued or fused between the outer lateral surface of the carrier body 502 of the ion-selective electrode 501 and the inner lateral surface of the housing 522 of the reference electrode 520. At the end located opposite the diaphragm 524, the housing 522 of the reference electrode 520 is sealed in a liquid-tight manner. The second cavity 523 is filled with a reference electrolyte that is contacted by an electrically conducting reference element 525. The reference electrolyte can be a highly concentrated aqueous KCl solution. The reference element 525 can be formed of silver chloride-coated silver wire, for example. It is led out of the cavity 523 and connected to an input of the measuring circuit 521.

The measuring circuit 521 is arranged in an electronics housing 526 fixedly connected to the reference electrode 520 and the ion-selective electrode 501. It is configured to detect a voltage between the potential lead 507 of the ion-selective electrode 501 and the reference element 525 of the reference electrode 521 and to generate a measurement signal that is dependent on the voltage. As mentioned at the outset, when the front end region of the sensor 500 comprising the sensor element body 504 and the diaphragm 524 is immersed in a measuring fluid, for example water, a voltage that is dependent on the pH value of the measuring fluid forms between the reference electrode 521 and the ion-selective electrode 501. The measurement signal of the measuring circuit 521 therefore represents the pH value to be measured. The measuring circuit 521 can be further configured to output the measurement signal to a further processing unit via a cable 527 and/or wirelessly.

1. A method of manufacturing a sensor element for measuring a measurand that is dependent on an ion activity in a measuring fluid, the method comprising:
joining a carrier body comprising a base body, which defines a cavity, to a sensor element body, wherein the base body comprises a liquid-impermeable, electrically insulating ceramic material and includes at least one through-opening to the cavity, and
wherein the sensor element body comprises an ion-selective glass such that a surface of the carrier body contacts the sensor element body and is integrally joined to the sensor element body at least at individual fixation points.

2. The method of claim 1, further comprising electrically contacting the sensor element body via the at least one through-opening of the base body.

3. The method of claim 1, wherein the surface of the carrier body includes at least one electrically conductive partial surface, and wherein the carrier body and the sensor element body are integrally joined to one another such that the electrically conductive partial surface is at least partially covered by the sensor element body.

4. The method of claim 3, further comprising electrically contacting the electrically conductive partial surface via the at least one through-opening of the base body.

5. The method of claim 1, wherein the through-opening extends in a longitudinal direction, extending substantially perpendicular to the surface of the carrier body contacting the sensor element body, and has a diameter, in a direction perpendicular to the longitudinal direction, of more than 0.1 μm.

6. The method of claim 1, wherein the carrier body is rod-shaped or tubular.

7. The method of claim 1, wherein the integral joining includes soldering with glass solder or an enamel glass preparation.

8. The method of claim 1, wherein the integral joining includes irradiating, with laser radiation, at least one or more individual fixation points located in an interface between the sensor element body and the carrier body.

9. The method of claim 1, wherein the integral joining includes using molecular adhesion forces to join of a surface region of the sensor element body to the surface of the carrier body.

10. The method of claim 1, wherein the base body is tubular with an end face in which the at least one through-opening is disposed, the sensor element body has a circular disk shape, and the sensor element body is joined to the end face of the tubular base body as to cover the at least one through-opening as to thereby close the cavity defined by the base body.

11. The method of claim 1, wherein the ion-selective glass of the sensor element body is a pH-selective glass.

12. A method of manufacturing an ion-selective electrode for electrochemical measurements, the method comprising:
manufacturing a sensor element according to the method of claim 1; and
electrically contacting at least one region of the sensor element body comprising the ion-selective glass with an electrically conductive potential lead.

13. The method of claim 12, wherein the electrically contacting comprises:
introducing an inner electrolyte into a cavity of the ion-selective electrode, which is at least partially defined by the carrier body, such that the inner electrolyte is in contact with a rear side of the sensor element body adjacent the carrier body via the at least one through-opening; and
contacting the inner electrolyte with a pick-up electrode.

14. The method of claim 12, wherein the surface of the carrier body of the sensor element includes at least one electrically conductive partial surface, and the manufacturing of the sensor element comprises:
integrally joining the carrier body and the sensor element body to one another such that the electrically conductive partial surface is at least partially covered by the sensor element body, and
wherein the electrically contacting of the sensor element body comprises electrically contacting the electrically conductive partial surface and/or the sensor element body via the at least one through-opening of the base body.

15. An ion-selective electrode for electrochemical measurements, comprising:
a carrier body comprising a base body comprising a liquid-impermeable, electrically insulating ceramic material, the base body including at least one through-opening;
a sensor element body formed of an ion-selective glass, which is integrally joined to a surface of the carrier body at least at individual fixation points; and
a potential lead contacting the sensor element body in an electrically conducting manner via the at least one through-opening.

16. The ion-selective electrode of claim 15, wherein:
the surface of the carrier body includes at least one electrically conductive partial surface;
the carrier body and the sensor element body are integrally joined to one another such that the electrically conductive partial surface is at least partially covered by the sensor element body and contacts the sensor element body in an electrically conducting manner; and
the potential lead comprises an electrical conductor which contacts the electrically conductive partial surface in an electrically conducting manner via the through-opening.
